(19) United States
(12) Patent Application Publication
(10) Pub. No.: US 2007/0025023 A1
(43) Pub. Date: Feb. 1, 2007

(54) Magnetic head slider with suppressed flying height reduction and magnetic hard disk drive

(75) Inventors: Hidekazu Kohira, Kanagawa-ken (JP); Jianhua Li, Kanagawa (JP); Junguo Xu, Ibaraki (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/190,239

(22) Filed: Jul. 26, 2005

(51) Int. Cl. G11B 5/60

(52) U.S. Cl. 360/236.2; 360/235.8; 360/235.6; 360/235.7; 360/236.3

(57) ABSTRACT

Embodiments of the invention provide Femto and below form factor magnetic head slider designs both capable of minimizing reduction of its flying height at high altitude and lower flying height sensitivity on manufacturing process tolerance. In one embodiment, the air bearing surface of a magnetic head slider includes a plurality of inlet rails respectively having inlet rail surfaces, a step bearing surface extending at a predetermined first depth from a reference plane including the inlet and the outlet rail surfaces, a negative surface extending in a plane at a predetermined second depth greater than the first depth from the reference plane, longitudinal carbon islands of a predetermined height formed on the inlet rails, and an outlet rail having an outlet rail surface flush with the inlet rail surfaces and holding a magnetic R/W head. The step bearing surface extends at a predetermined first depth from a reference plane. The air bearing surface further includes two or more stepped leading air flow surfaces and three or more rising wall profiles.

### BACKGROUND OF THE INVENTION

The present invention relates to a magnetic disk drive and, more particularly, to a magnetic head slider capable of both suppressing the decrease of its flying height when used at high altitude or low pressure environments and reducing its flying height sensitivity on manufacturing process tolerance.

Achieving higher areal magnetic recording density of magnetic disk drive requires an extremely small and constant spacing between the air bearing slider, which carries the recording element, and the magnetic disk. At the same time, physical contact between the slider and disk must be minimized under a growing demanding variety of operational and environmental conditions. The move to smaller and smaller disk drives has placed increasing demands on power consumption, shock performance, and disk storage capacity. One of the key contributors to achieving these demanding requirements has been the reduction of slider form factor. The reduction of slider form factor can significantly improve the slider's mechanical performances and greatly reduce manufacturing cost. It is very necessary to suppress the reduction of flying height as effectively as possible when the magnetic disk drive is used at high altitude and to decrease flying height sensitivity on manufacturing process tolerances of the smaller and smaller slider.

Generally, the flying height of the slider decreases at high altitude because the mean free path of the air serving as a working fluid for the slider increases at high altitude. The reduction of the flying height is undesirable from the viewpoint of the reliability of the magnetic disk drive because the reduction of the flying height increases the possibility of the slider coming into contact with the magnetic disk. It is particularly desirable for a magnetic disk drive using a 2.5 in and 1.8 in and micro-drive and built in a portable information processing device that is often used at high altitude to prevent the change of the flying height of the slider with the increase of altitude, i.e., with the drop of the atmospheric pressure.

The miniaturization of the slider and the reduction of the diameter of the disk have progressively advanced with the miniaturization of the magnetic disk drive. Since a miniaturized slider has a small area and the circumferential speed of a small-diameter magnetic disk is low, negative pressure produced by the miniaturized slider is low; consequently, suppression of the reduction of the flying height at high altitude by those known prior art techniques has become progressively difficult.

A technique for suppressing the reduction of the flying height of the slider with the increase of the altitude is disclosed in U.S. patent application Ser. No. 11/104,998, filed Apr. 12, 2005 (Patent Document 1). According to patent document 1, the reduction of the flying height at high altitude can be effectively suppressed by the slider design with two longitudinal, separate carbon islands of a predetermined height h formed on the inlet rails.

Another technique for suppressing the reduction of the flying height of the slider with the increase of the altitude is disclosed in JP-A No. 2000-57724 (Patent Document 2). According to Patent document 2, the reduction of the flying height at high altitude can be effectively suppressed by optimizing the ratio between the depth of a step bearing surface and the depth of a negative-pressure groove.

Known magnetic head sliders similar in construction to a magnetic head slider according to the present invention are disclosed in JP-A Nos. 6-203514, 8-102164, 11-25629, 2003-151233, 2001-250215 and 2000-260015, and PCT patent Publication No. WO2003/515869. All those magnetic head sliders used a rail having a stepped surface or provided with a pad on air inlet side to reduce adhesion and friction between the slider and magnetic disk when the slider comes into contact with the magnetic disk.

### BRIEF SUMMARY OF THE INVENTION

A way to increase recording density in which a magnetic disk drive records data without losing the reliability of the magnetic disk drive is to reduce flying height across the entire surface of a magnetic disk and to suppress the reduction of the flying height at high altitude.

The miniaturization of the slider and the reduction of the diameter of the disk have progressively advanced with the miniaturization of the magnetic disk drive. Since a miniaturization of the slider has a small area and the circumferential speed of a small-diameter magnetic disk is low, negative pressure that can be produced by the miniaturized slider is low. Therefore, suppression of the reduction of the flying height at high altitude by those known techniques has become progressively difficult. Suppression of the reduction of the flying height of a small slider with 0.85 mm in overall length and 0.7 mm in overall width generally called Femto and below form factor slider at high altitude is difficult and further improvement of a small slider is desired.

The present invention has been made in view of such circumstances and it is a feature of the present invention to provide a magnetic head slider capable of minimizing the reduction of its flying height at high altitude and the lower sensitivity on manufacturing process tolerance.

According to one aspect of the present invention, there is provided a magnetic head slider comprising: a length less than or equal to 0.85 mm, a width less than or equal to 0.7 mm, and a thickness less than or equal to 0.23 mm, an air inlet end, an air outlet end and an air bearing surface wherein the air bearing surface includes a plurality of inlet rails respectively having inlet rail surface, a step bearing surface extending at a predetermined first depth from a reference plane including the inlet and the outlet rail surfaces, a negative surface extending in a plane at a predetermined second depth greater than the first depth from the reference plane, and longitudinal carbon islands of a predetermined height formed on the inlet rails, and an outlet rail having an outlet rail surface flush with the inlet rail surfaces and holding a magnetic R/W head wherein the step bearing surface extends at a predetermined first depth from a reference plane, and wherein the air bearing surface further includes two or more stepped leading air flow surfaces and rising wall profiles.

According to another aspect of the present invention, there is provided a magnetic head slider comprising: a length less than or equal to 0.85 mm, a width less than or equal to 0.7 mm, and a thickness less than or equal to 0.23 mm, an air inlet end, an air outlet end and an air bearing surface wherein the air bearing surface includes a plurality of inlet rails respectively having inlet rail surface, a step bearing surface extending at a predetermined first depth from a reference plane including the inlet and the outlet rail surfaces, a negative surface extending in a plane at a predetermined second depth greater than the first depth from the reference plane, and longitudinal carbon islands of a predetermined height formed on the inlet rails, and an outlet rail having an outlet rail surface flush with the inlet rail surfaces and holding a magnetic R/W head wherein the step bearing surface extends at a predetermined first depth from a reference plane; and wherein the air bearing surface further includes two or more stepped leading air flow surfaces and rising wall profiles; and wherein a load point is located to the point between the air inlet and the center of the magnetic head slider.

According to the present invention, the reduction of the flying height of the magnetic head slider at high altitude can be prevented, and the sensitivity of the flying height on the manufacturing process tolerance can be reduced and thereby the reliability of a magnetic disk drive can be improved.

### BRIEF DESCRIPTION OF THE DRAWINGS

FIG. 1 is a perspective view of a magnetic head slider in a first embodiment according to present invention.

FIG. 2 is a plan view of a magnetic head slider in the first embodiment.

FIG. 3 is a three-dimensional diagram showing a pressure distribution on the magnetic head slider in the first embodiment.

FIG. 4 is a perspective view of a magnetic head slider in the first embodiment flying over a magnetic disk.

FIG. 5 is a plan view of a magnetic head slider in Comparative example 1.

FIG. 6 is a graph showing simulated flying height profiles of a magnetic head slider in the first embodiment and the magnetic head slider in comparative examples for 0 and 3000 m altitudes.

FIG. 7 is a graph showing simulated flying height 3 Sigma of a magnetic head slider in the first embodiment and magnetic head slider in Comparative example 1.

FIG. 8 is a graph showing simulated flying height profiles of a magnetic head slider in the first embodiment for the sub-deep depth tolerance.

FIG. 9 is a plan view of a magnetic head slider in a second embodiment according to the present invention.

FIG. 10 is a plan view of a magnetic head slider in a third embodiment according to the present invention.

FIG. 11 is a plan view of a magnetic head slider in a fourth embodiment according to the present invention.

FIG. 12 is a perspective view of a magnetic head drive provided with a magnetic head slider according to the present invention, and a load/unload mechanism.

### DETAILED DESCRIPTION OF THE INVENTION

### First Embodiment

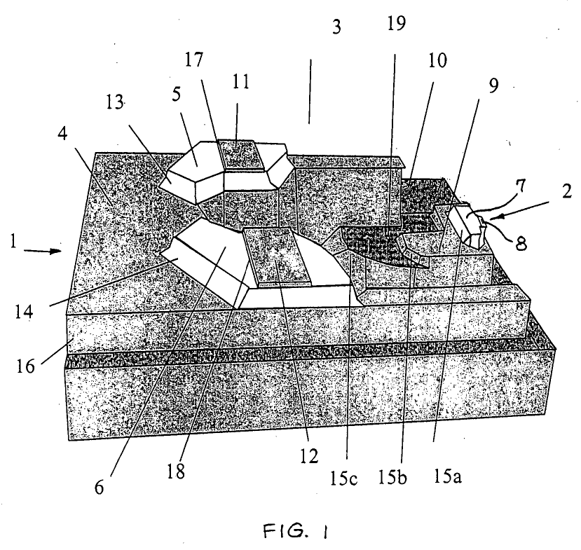

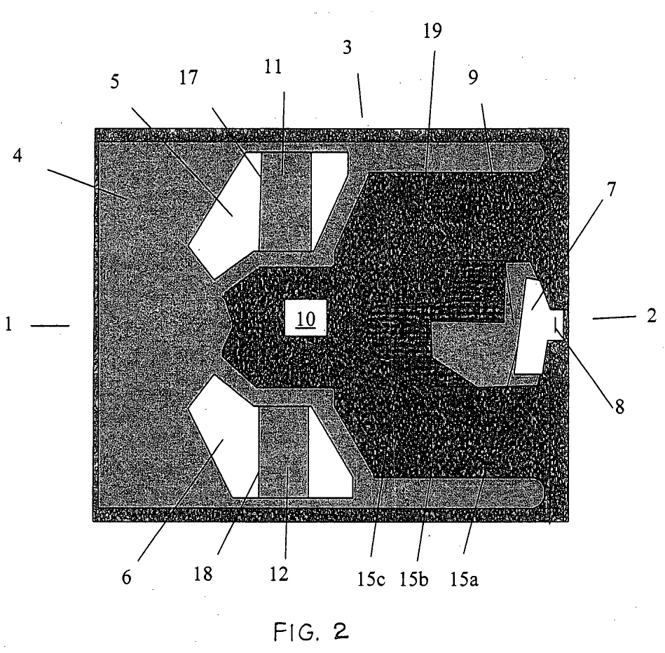

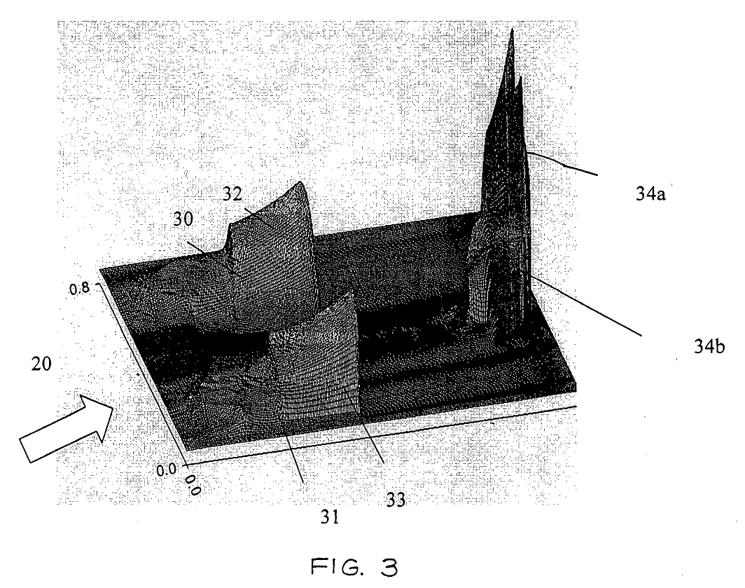

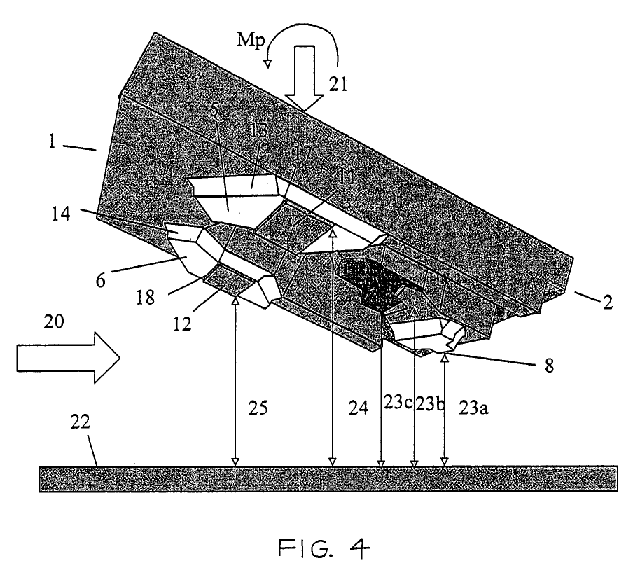

A magnetic head slider in a first embodiment according to the present invention and a magnetic disk drive provided with this magnetic head slider will described with reference to the accompanying drawings. FIG. 1 is a perspective view of the magnetic head slider in the first embodiment; FIG. 2 is a plan view of the slider shown in FIG. 1. FIG. 3 is a three-dimensional diagram showing a pressure distribution on the slider in FIG. 1, and FIG. 4 is a perspective view of the slider flying over a disk.

Referring to FIGS. 1 to 4, the slider in the first embodiment has an air inlet end 1, an air outlet end 2 and an air bearing surface 3. The air bearing surface 3 includes an inlet step bearing surface 4, inlet rails 5 and 6 respectively having an inlet rail surfaces, an outlet rail 7 having an outlet rail surface and holding a magnetic head 8, two outlet step bearing surfaces 9 and 19, three rising wall profiles 15a, 15b and 15c, a negative-pressure groove 10, and island 11 and 12 formed on the respective inlet rails 5 and 6.

The inlet rail surfaces of the inlet 5 and 6 and the outlet rail surface of the outlet rail 7 are substantially flush with each other and included in a reference plane. Air 20 that flows through a space between a slider and a magnetic disk 22 produces an aerodynamic pressure to cause the slider to fly over the magnetic disk 22. Thus, the inlet rail surfaces 5 and 6 and the outlet rail surface of the outlet rail 7 serve as positive-pressure rail surfaces.

The inlet step bearing surface 4 and the outlet step bearing surface 9 are substantially flush with each other and included in a plane including the inlet rail surface of the rails 5 and 6 and the outlet rail surface of the outlet rail 7. Air 20 passes through the air inlet end 1 into the space between the slider and the magnetic disk 22, then flows along the inlet step bearing surface 4 and the outlet step bearing surfaces 9 and 19. The aerodynamic pressure of air 20 is increased by rising surface 13, 14, 15a, 15b and 15c. Air 20 of an increased aerodynamic pressure flows along the inlet rail surfaces of the inlet rails 5 and 6 and the outlet rail surfaces of the outlet rail 7.

The aerodynamic pressure of air 20 flowing along the inlet rail surfaces of the inlet rails 5 and 6 and reaching the islands 11 and 12 is further increased to a high aerodynamic pressure sufficient to lift up the slider by the second rising surfaces 17 and 18, i.e., the front surfaces of the island 11 and 12. The height of the second rising surfaces 17 and 18 of the islands 11 and 12 from the inlet rail surfaces of the inlet rails 5 and 6 is on the order of 20 nm. The islands 11 and 12 need to have certain length in the flowing direction of air 20, i.e., along the length of the slider, to produce a high aerodynamic pressure by the islands 11 and 12. Such a high aerodynamic pressure, namely, an aerodynamic lift, can be produced by the island 11 and 12 having the second rising surfaces 17 and 18 of such a very low height.

The stepped air flow surfaces 9 and 19 and rising wall profiles 15a, 15b and 15c are the foremost feature of the present embodiment. The first rising surfaces 13 and 14 of the inlet rails 5 and 6 produce aerodynamic pressure 30 and 31 to lift up the slider, and the second rising surfaces 17 and 18 of islands 11 and 12 increase the aerodynamic pressures to higher aerodynamic pressures 32 and 33. The first rising profile 15c produces the aerodynamic pressure of the airflow, the aerodynamic pressure is increased while the air flows through the rising wall profiles 15b and 15c, and produces the aerodynamic pressure 34b and 34a at outlet rail 7.

The length of the stepped surfaces 9 and 19 necessary for producing a high positive pressure is about 50 μm or longer, preferably about 100 μm or longer, and the stepped surface 19 is wider than stepped surface 9. In this embodiment, the length of the island 11 and 12 is about 100 μm.

Since the arrangement of the rising surfaces at two steps is effective in producing a high aerodynamic lift, the sizes of the inlet rails 5 and 6 and the outlet 7 can be reduced, therefore the negative pressure area is increased.

The inlet rail surfaces of the inlet rails 5 and 6 and the outlet rail surfaces of the outlet rail 7 that serve in producing the aerodynamic pressure are positive-pressure rail surfaces. Since the area of the rail surfaces of the slider of the present embodiment necessary for producing a predetermined aerodynamic lift can be reduced, the reduction of the flying height at high altitude can be minimized, which will be described later.

The depth 16 of the negative-pressure groove 10 from the plane including the inlet step bearing surface 4 is on the order of about 800 nm. The depth of the negative-pressure groove 10 from the reference plane including the inlet rail surfaces of the inlet rails 5 and 6 is on the order of about 1 μm.

The depth of the stepped surface 19 from the plane including the outlet step bearing surface 9 is on the order of about 300 nm. The depth of stepped surface 9 from the reference plane including the inlet rail surfaces of the outlet rail 7 is on the order of about 200 nm.

The slider in the first embodiment is the so-called Femto slider with 0.85 mm in length 0.7 mm in width and 0.23 mm in thickness. Generally, the area of the negative-pressure groove 10 decreases with the decrease of the area of the slider, negative pressure that can be produced by the slider decreases with the decrease of the area of the slider and, consequently, the reduction of the flying height at high altitude increases.

At present, the magnetic disk drive has been progressively miniaturized and magnetic disks of smaller diameters that are rotated at low rotational speeds have been used. Consequently, negative pressure that can be produced by the slider has been progressively decreased. These matters are factors that increase the reduction of flying height at high altitude.

As mentioned above, the present embodiment achieves the minimization of the reduction of the flying height at high altitude successively because the area of the rails of the slider in the first embodiment necessary for producing a predetermined aerodynamic lift can be reduced.

The effect of the first embodiment will be concretely described. Air 20 causes the slider to fly over the disk 22 in an inclined position such that the flying height of the air inlet end 1 is higher than that of the air outlet end 2. Consequently, the flying height 23 of the outlet rail surface of the outlet rail holding the magnetic head 8 is the lowest.

If the flying height 24 of the back end of the island 11 and the flying height 25 of the back end of the island 12 is lower than the flying height 23 of the outlet rail surface of the outlet rail 7, the islands 11 and 12 contact with the disk 22. If the islands 11 and 12 contact with the disk 22, the slider vibrates significantly and, in the worst case, the slider would crash. Therefore, the islands 11 and 12 of the slider must be designed such that the slider flies in a proper position and the flying heights 24 and 25 never decrease less than the flying height 23.

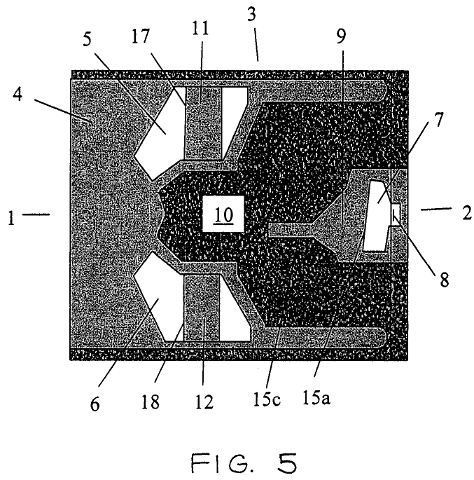

FIG. 5 is a plan view of a prior slider in Comparative example 1 disclosed in Patent document 1. This prior slider differs from the slider in the first embodiment in that the former does not include stepped surface 19 and rising wall profile 15c that have an effect of increasing the aerodynamic pressure. Therefore, the prior slider needs larger rail surfaces 7 than those of the first embodiment in order to make the slider fly at the same flying height, hence reducing the area of negative pressure and further decreasing the air bearing stiffness.

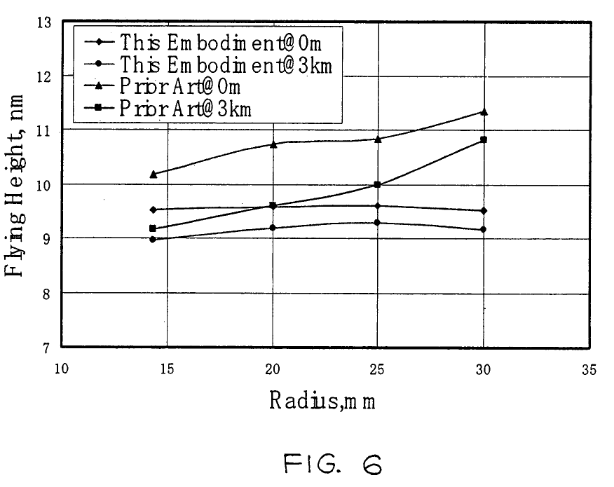

FIG. 6 is a graph showing calculated flying height profiles, i.e., flying height distributions along the radius of a disk, of the slider in the first embodiment at altitudes of 0 m and 3000 m. The normal operation of the magnetic disk drive must be guaranteed for an altitude of 3000 m (about 0.7 atm.) and hence the reduction of the flying height at an altitude of 3000 m must be suppressed to the least possible extent. The disk was rotated at 5400 rpm.

As illustrated in FIG. 6, the flying height reduction ratio, i.e., the ratio of a reduction of the flying height of the slider due to the increase of the altitude from 0 m to 3000 m, is in a range of about 6% to about 7%.

Flying height profiles of the sliders in Comparative example 1 shown in FIG. 5 at altitudes of 0 m and 3000 m are shown in FIG. 6. Flying height reduction ratio, i.e., the ratio of reductions of the flying heights of the sliders due to the increase in altitude from 0 m to 3000 m normalized by the flying height at the sea level. The flying height reduction ratio for the comparative example is in a range of about 13% to 20%. As illustrated in FIG. 6, the reduction of the flying height of the slider in the first embodiment due to the increase in altitude is very small.

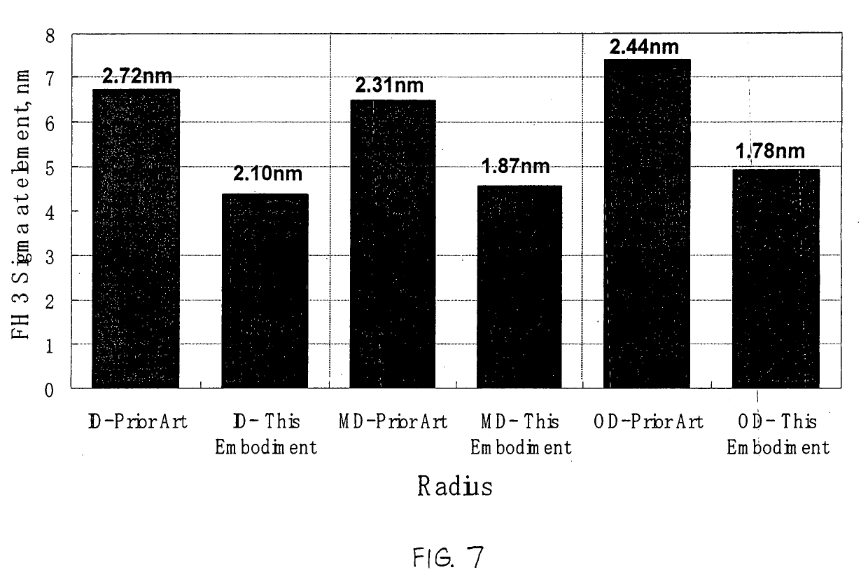

As mentioned above, the step surface 19, 9 and rising wall profiles 15a, 15b and 15c can increase the air bearing stiffness in translation and pitch direction in the trailing pad due to increasing the pressure gradient. The increase of air bearing stiffness also reduces its sensitivity on the manufacturing process tolerance. FIG. 7 is a graph showing calculated flying height 3 Sigma of the magnetic head slider in a first embodiment and magnetic head slider in Comparative example 1. A 0.5˜0.6 nm reduction in flying height is achieved in the first embodiment compared to the Comparative example of a prior slider.

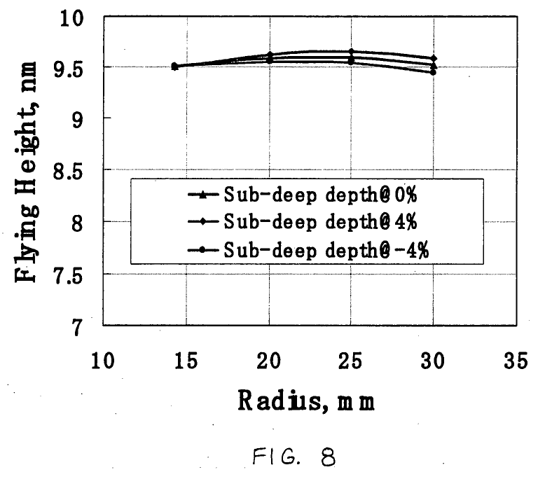

An additional step surface and relative rising wall profile is in the first embodiment compared to the prior sliders; consequently, an additional process is done in the process of manufacturing, so that this process tolerance effect on slider flying height should be evaluated. FIG. 8 shows the simulated flying height profiles of the magnetic head slider in a first embodiment for a +/−4% sub-deep depth tolerances, the effect of the sub-deep depth tolerance is very small; that is, the new structure of the slider in the first embodiment has very small effect on the flying height 3 Sigma.

A load point where a suspension load 21 is applied to the slider in the first embodiment is set to the point between the air inlet end 1 and the center of the slider, and corresponds to the opposite side of the islands 11 and 12. When the aerodynamic pressures 32 and 33 acting on the islands 11 and 12 decrease at high altitude, a moment Mₚ tending to decrease the flying height of the air inlet end 1 acts on the slider to suppress the decrease of the flying height 23 of the air outlet end 2.

### Second Embodiment

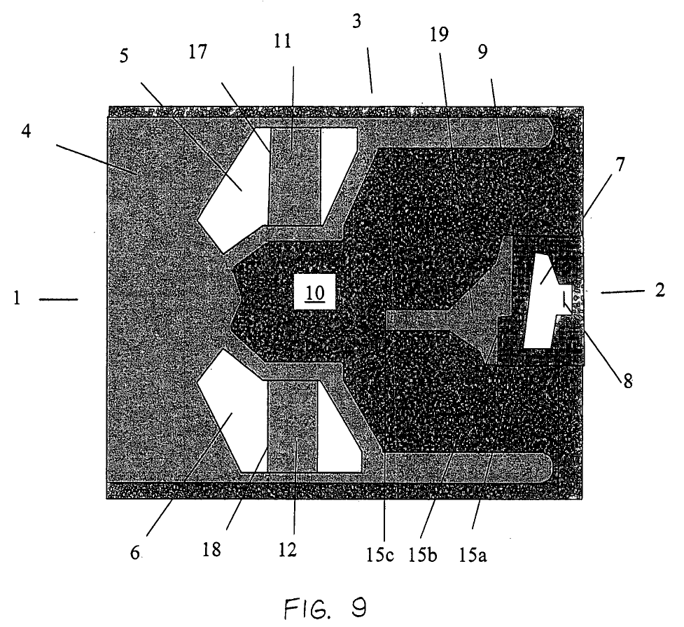

FIG. 9 is a plan view of a magnetic head slider in a second embodiment according to the present invention. The slider in second embodiment has outlet rail 7, and stepped surfaces 9, 19 and rising wall profiles 15a, 15b and 15c, where the depth of surface 9 is different from that of surface 4 from the reference plane. The difference provides more choices for air bearing design. In this embodiment, stepped air surface 9 may be higher or lower than stepped air surface 4. Air flow comes through the air inlet end 1 into the space between the slider and magnetic disk 22, then flows along the inlet step bearing surface 4 and the outlet step bearing surfaces 19 and 9. The aerodynamic pressure of air 20 is increased by rising profiles 13, 14, 15a, 15b and 15c. Air 20 of an increased aerodynamic pressure flows along the inlet rail surfaces of the inlet 5 and 6 and the outlet rail surface of the outlet rail 7. The depth difference between surface 4 and 9 can result in the difference of air bearing stiffness in the inlet rail and outlet rail, and achieve a slider design with lower altitude sensitivity.

### Third Embodiment

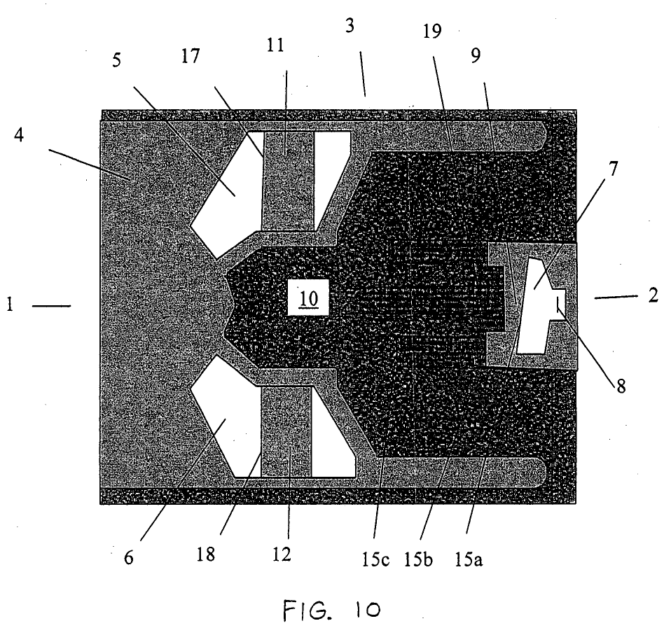

FIG. 10 is a plan view of a magnetic head slider in third embodiment according to the present invention. The stepped surface 19 is formed by a double U shape. The first rising profile 15a produces the aerodynamic pressure at the outlet rail 7, then second rising profile 15b and third profile 15c further increases the aerodynamic pressure 34b and 34a. The double U shape surface 19 and U shape 9 can increase damping and reduce the flying height sensitivity of the velocity such that the dynamic performances of the slider are improved.

### Fourth Embodiment

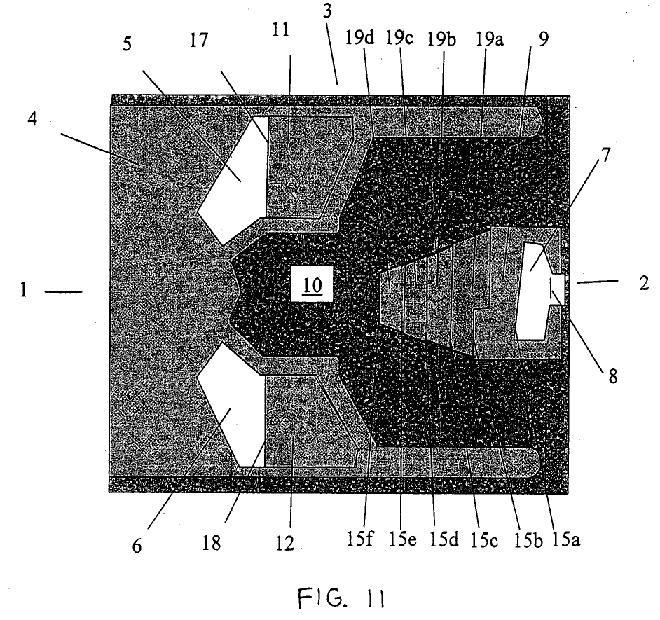

FIG. 11 is a plan view of a magnetic head in a fourth embodiment according to the present invention. The slider is less than 0.85 mm in length, less than 0.7 mm in width and less than 0.23 mm in thickness. Generally, the area of the negative-pressure groove 10 decreases with the decrease of the area of the slider, negative pressure that can be produced by the slider decreases with the decrease of the area of the slider and, consequently, the reduction of the flying height at high altitude increases. For that, more step surfaces 19a, 19b, 19c, 19d and rising wall profiles are formed in the front of the outlet rail 7 in order to increase the air bearing stiffness, hence the flying height loss due to higher altitude is suppressed and the flying height sensitivity on manufacturing process tolerance is reduced.

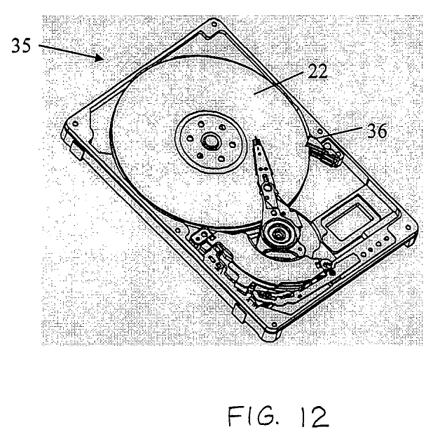

FIG. 12 is a perspective view of a magnetic disk drive 35 provide with one of the magnetic head sliders of the first to fourth embodiments according to the present invention. The magnetic disk drive 35 is provided with a load/unload mechanism. The load/unload mechanism holds the magnetic head slider on a ramp while the magnetic disk drive is stopped or holds the magnetic head slider at a working position for a recording or reproducing operation above a magnetic disk 22 while the magnetic disk drive is in operation.

The slider of the foregoing embodiments capable of reducing the reduction of flying height at high altitude improves the reliability of the magnetic head drive. The effect of the slider of the present invention is particularly significant when the slider of the present invention is applied to a magnetic disk drive provided with small magnetic disks smaller than 2.5-inch magnetic disks.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A magnetic head slider comprising:
an air inlet end;
an air outlet end; and
an air bearing surface;
wherein the air bearing surface includes:
a plurality of inlet rails respectively having inlet rail surfaces;
a step bearing surface extending at a predetermined first depth δ1 from a reference plane including the inlet and the outlet rail surfaces;
a negative-pressure surface extending in a plane at a predetermined second depth δ2 greater than the first depth δ1 from the reference plane;
longitudinal islands of a predetermined height h formed on the inlet rails; and
an outlet rail having an outlet rail surface flush with the inlet rail surfaces and supporting a magnetic R/W head;
wherein the step bearing surface extends at a predetermined first depth δ1 from a reference plane; and
wherein the air bearing surface further includes at least two stepped leading air flow surfaces and three rising wall profiles.

2. The magnetic head slider according to claim 1,
wherein a cavity floor surface extends at a predetermined depth δs3 from the reference plane, and
wherein the stepped leading air flow surfaces include an outlet step bearing surface extending at predetermined depth δs1 from the reference plane, and an outlet sub-deep surface extending at a predetermined depth δs2 from the reference plane.

3. The magnetic head slider according to claim 2,
wherein the depth δs3 of the cavity floor surface from the reference plane is larger than the depth δs2 of the outlet sub-deep surface from the reference plane, and δs2 is larger than the depth δs1 of the outlet step bearing surface from the reference plane.

4. The magnetic head slider according to claim 3,
wherein the outlet sub-deep bearing surface is behind the cavity floor surface, but in front of the outlet step bearing surface.

5. The magnetic head slider according to claim 2,
wherein the outlet step bearing surface in a rear pad is lower or higher than the inlet step bearing surface in a front pad.

6. The magnetic head slider according to claim 1,
wherein the stepped leading air flow wall profiles have curved or straight surface boundary lines.

7. The magnetic head slider according to claim 1,
wherein the stepped leading air flow wall profiles each have a sloped angle.

8. The magnetic head slider according to claim 1,
wherein the air bearing surface and the islands are coated with the same material.

9. A magnetic disk drive provided with the magnetic head slider stated in claim 1.

10. A magnetic head slider comprising:
an air inlet end;
an air outlet end; and
an air bearing surface;
wherein the air bearing surface includes:
a plurality of inlet rails respectively having inlet rail surfaces;
a step bearing surface extending at a predetermined first depth δ1 from a reference plane including the inlet and the outlet rail surfaces;
a negative-pressure surface extending in a plane at a predetermined second depth δ2 greater than the first depth δ1 from the reference plane;
longitudinal islands of a predetermined height h formed on the inlet rails; and
an outlet rail having an outlet rail surface flush with the inlet rail surfaces and holding a magnetic head;
wherein the step bearing surface extends at a predetermined first depth δ1 from a reference plane in a rear pad including two stepped leading air flow surfaces and three rising wall profiles; and
wherein a load point is located to the point between the air inlet end and the center of the magnetic head slider.

11. A magnetic disk drive provided with the magnetic head slider stated in claim 10.

12. A magnetic head slider comprising:
an air inlet end;
an air outlet end;
a negative-pressure groove; and
an air bearing surface;
wherein the air bearing surface includes:
a longitudinal bearing surface extending toward the air outlet end from the air inlet end;
a first island formed on the air bearing surface and having a first step rising from the bearing surface, and a second island formed on the first island and having a second step rising from the first step in the front pad; and
a step bearing surface extending at a predetermined first depth δ1 from a reference plane in the rear pad includes a plurality of stepped leading air flow surfaces and rising wall profiles.

13. A magnetic disk drive comprising:
a magnetic disk; and
a magnetic head slider having an air inlet end, an air outlet end, a negative-pressure groove, and an air bearing surface;
wherein the air bearing surface includes:
a longitudinal bearing surface extending toward the air outlet end from the air inlet end;
a first island formed on the air bearing surface and having a first step rising from the bearing surface, and a second island formed on the first island and having a second step rising from the first step in the front pad; and
a step bearing surface extending at a predetermined first depth δ1 from a reference plane in the rear pad includes a plurality of stepped leading air flow surfaces and rising wall profiles.

14. The magnetic head slider according to claim 13,
wherein the air bearing surface further includes at least two stepped leading air flow surfaces and three rising wall profiles.

15. The magnetic head slider according to claim 13,
wherein a cavity floor surface extends at a predetermined depth δs3 from the reference plane; and
wherein the stepped leading air flow surfaces include an outlet step bearing surface extending at a predetermined depth δs1 from the reference plane, and an outlet sub-deep surface extending at a predetermined depth δs2 from the reference plane.

16. The magnetic head slider according to claim 15,
wherein the depth δs3 of the cavity floor surface from the reference plane is larger than the depth δs2 of the outlet sub-deep surface from the reference plane, and δs2 is larger than the depth δs1 of the outlet step bearing surface from the reference plane.
